(19) United States
(12) Patent Application Publication
(10) Pub. No.: US 2015/0291405 A1
(43) Pub. Date: Oct. 15, 2015

(54) METHOD AND FACILITY FOR TREATING CORK

(71) Applicant: CENTRE NATIONAL DE LA RECHERCHE SCIENTIFIQUE - CNRS, Paris (FR)

(72) Inventors: Guillaume Herlem, Besancon (FR); Tijani Gharbi, Besancon (FR)

(21) Appl. No.: 14/435,830

(22) PCT Filed: Oct. 15, 2013
(86) PCT No.: PCT/FR2013/052455

§ 371 Date: Apr. 15, 2015

(30) Foreign Application Priority Data
Oct. 15, 2012 (FR) 12 59803

(51) Int. Cl. B67B 1/03; B67B 1/04; B67B 1/00; B27K 5/00; B27K 7/00

(52) U.S. Cl. CPC B67B 1/03; B27K 5/0015; B27K 7/00; B67B 1/005; B67B 1/04

(57) ABSTRACT

Cork stoppers are treated by subjecting the cork to an electrochemical dehalogenation by electrolysis.

The present invention relates to methods and facilities for treating cork.

Cork has long been used in winemaking for sealing wine bottles. This is primarily because cork has all the characteristics desired for a wine bottle stopper.

One of the few disadvantages of cork is the possible presence of chlorinated compounds such as 2,4,6-trichloroanisole (TCA), which can sometimes give wine which is commonly known as ‘cork taint’. This unpleasantness is the cause of significant losses in yearly wine production and of sometimes major expenses, especially in the insurance and restaurant industries.

As cork is a natural material, controlling the amount of TCA can be difficult to achieve on a scale compatible with the production and bottling processes of some producers.

U.S. 2008/245,132 claims to provide a method where cork stoppers are tested directly on the bottling line. However, this method requires complex equipment whose cost increases with the volume of cork stoppers being treated.

The present invention is intended to provide an improved method for treating cork.

To this end, the invention relates to a method for treating cork stoppers wherein the cork is subjected to an electrochemical dehalogenation by electrolysis.

With these arrangements, there is not only a testing for the possible presence of compounds that could be contaminants, but the cork is acted upon directly with a method that can easily be made compatible with production requirements.

In preferred embodiments of the invention, one or more of the following arrangements may possibly also be used:
a solution is provided comprising an electrolyte in contact with the cork, electrodes in contact with said solution, and a generator suitable for applying a difference in potential between the electrodes;
the solution and the surface of the electrodes in contact with the solution are provided in biocompatible materials;
the method has at least one of the following characteristics:
   one electrode is a cathode, and a cathode surface material is lead,
   one electrode is an anode, and an anode surface material is inert, preferably graphite,
   a solvent is an alcohol, preferably ethanol,
   an electrolyte is a salt present in wine, preferably a sodium salt, preferably selected from the list of sodium acetate and sodium tartrate,
   the cork is in the form of stoppers;
a tank containing the solution is provided, and the electrodes and the cork are immersed in the solution;
the method comprises at least one of the following characteristics:
   the cork is kept completely immersed in the solution,
   during the dehalogenation, a molecule contained in the haloanisole and halophenols groups is removed, preferably 2,4,6-trichloroanisole;
a halogen concentration is measured, and the dehalogenation is controlled according to said concentration;
cork stoppers are formed.

According to another aspect, the invention relates to a bottling method wherein such a method for treating cork is used, and wherein a bottle is sealed with one of said stoppers.

In another aspect, the invention relates to a facility comprising a cork supply unit, and an electrochemical station where the cork is subjected to an electrochemical dehalogenation by electrolysis, the facility further comprising a stopper shaping station, the facility optionally further comprising a sealing station where a wine bottle is sealed with a stopper.

In various aspects, stoppers for liquids other than wine can be treated with this method, particularly stoppers for other alcohols such as beer or cider for example.

Other features and advantages of the invention will become apparent from the following description of two of its embodiments, given by way of non-limiting example with reference to the accompanying drawings.

In the drawings:

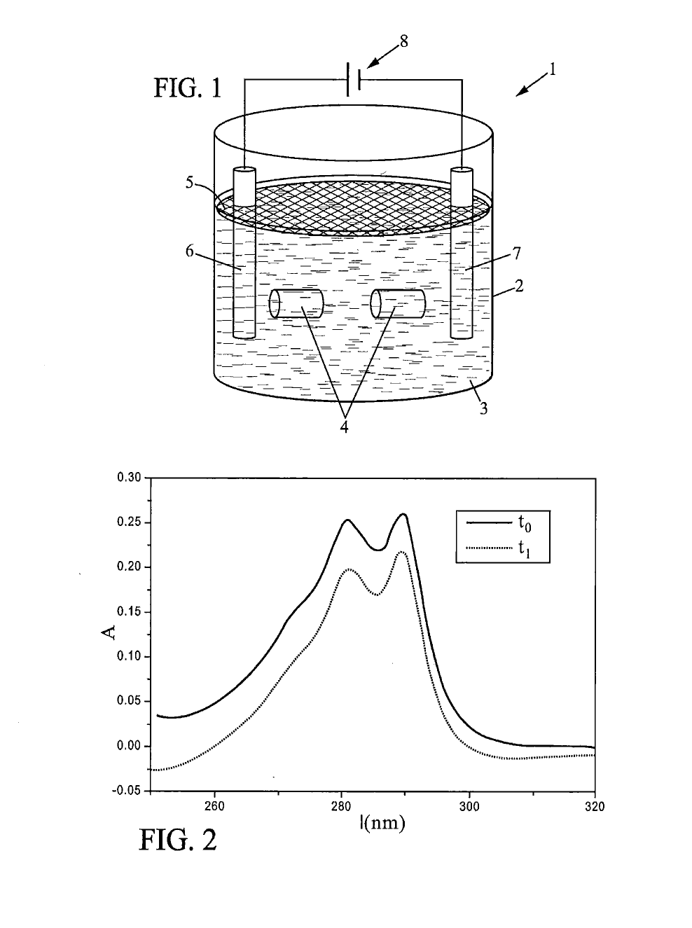

FIG. 1 is a perspective view of an example dehalogenation station,

FIG. 2 is an experimental curve from a process of controlling the amount of chlorine compound,

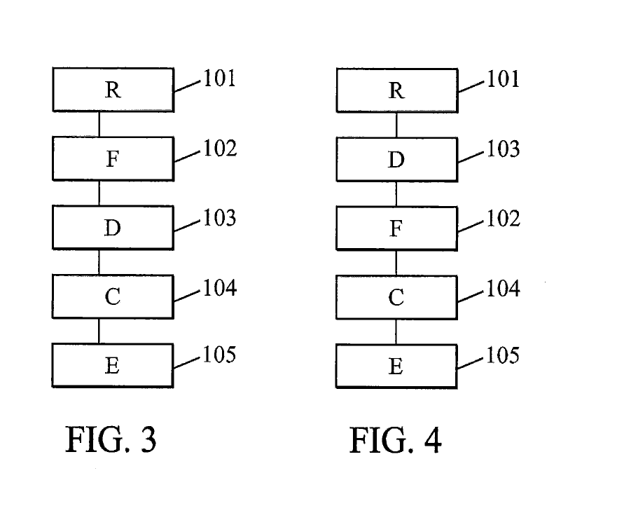

FIGS. 3 and 4 are diagrams illustrating bottling processes/facilities.

In the various figures, the same references designate identical or similar elements.

FIG. 1 shows an example of a dehalogenation station 1.

The station 1 comprises, for example, a tank 2 containing a liquid 3 solution in which the parts 4 to be treated are immersed. Two parts 4 are shown as examples. One to many parts can be treated simultaneously. A lid or grid 5 is placed on the surface of the solution, to ensure that each of the parts 4 are completely immersed.

The electrolytic system comprises the solution 3, an anode 6, a cathode 7, and an electrical generator 8. The electrical generator 8 is adapted to circulate electric current in the solution between the anode and cathode.

The parts 4 are made of cork. Cork is a natural material obtained from orchards, such as cork oak plantings. The parts 4 may also contain a chlorinated compound such as a haloanisole or halophenol for example. Examples of haloanisoles present in cork are for example 2,4,6-trichloroanisole (TCA), 2,3,4,6-tetrachloroanisole (TeCA), 2,3,4,5,6-pentachloroanisole (PCA), and 2,4,6-tribromoanisole (TBA). Examples of halophenols present in cork are for example 2,4,6-trichlorophenol (TCP), 2,3,4,6-tetrachlorophenol (TeCP), 2,3,4,5,6-pentachlorophenol (PCP), and 2,4,6-tribromophenol (TBP).

In the present embodiment, the parts 4 are stoppers having shapes suitable for plugging bottles, particularly wine bottles. Such a plug may be substantially cylindrical, as shown. The cylinder has an axis oriented along the axis of the neck of the bottle, and an outer diameter transverse to the axis that is greater, at rest, than the inside diameter of the neck of the bottle. In other embodiments, the stoppers may have more complex shapes, including having a tapered foot and/or a head that is integral with the foot and wider than said foot, extending out beyond the stoppered bottle.

The solution comprises a solvent and an electrolyte. The materials of the various components (in particular the solvent, electrolyte, surface of the electrodes, surface of the grid and/or surface of the tank) are provided so as to not adversely affect the wine. One can thus choose materials that are bio-compatible and in particular are compatible with wine.

The solvent may for example be an alcohol, for example ethanol.

The electrolyte may for example be a salt present in the future content of the bottles to be sealed. For certain wines, the electrolyte may thus be a salt present in the wine, such as a sodium salt for example. Acetate or sodium tartrate are therefore electrolytes which are suitable for this application.

The surface materials of the electrodes are preferably inert. One can therefore use graphite for the surface of the anode 6. It is possible to use lead for the cathode surface.

An example implementation of the method is described relative to FIG. 3. In a first step 101, cork is received (R), for example in raw form, at a receiving station. In a second step 102, stoppers are formed (F) from the raw cork at a shaping station. This step can include any conventional step for shaping stoppers from raw cork, such as cork treatments, including chemical treatments, and stopper shaping by any suitable method.

In a third step 103, the shaped stoppers are dehalogenated at a processing station. As mentioned above in relation to FIG. 1, the stoppers are immersed in the solution as parts 4, and are kept completely immersed by the grid 5. An electric current is generated in the solution by the generator 8, to electrolyze the chlorinated compounds of the stoppers. This step is carried out for a length of time. Periodically, a control step 104 which checks (C) the amount of chlorine compounds is carried out. This step can be implemented by any suitable known means. Where appropriate, this control step is associated with a predetermined threshold which is used to stop the electrolysis step. This control step is optional.

During the bottling step 105, the full bottle is sealed (E) with the treated cork at a bottling station. Optionally, additional conventional steps of processing the cork before sealing the bottle may be performed, and other conventional bottling steps.

In one embodiment, illustrated in FIG. 4, the electrolysis step is not applied to already shaped stoppers. Instead, the electrochemical dehalogenation step 103 is applied to parts 4 from which the stoppers will be shaped during a later shaping step 102.

Note that all the above steps are not necessarily carried out by one person in one place. The different steps may be implemented by various companies, possibly in different countries.

FIG. 2 shows an example of checking the amount of chlorine compounds (in this case TCA) dissolved in a solution during an electrolysis process. The solid curve shows the UV absorbance of the solution as a function of wavelength at the start of electrolysis (time t₀), and the dotted line after a predetermined time t₁. In this example, an electrolysis bath was synthesized with a tartrate salt (sodium tartrate) dissolved in ethanol to saturation, with the addition of TCA 10⁻⁴ M. The electrolysis was carried out on graphite electrodes at constant potential of 50 V. The current was about 240 microamperes. Time t₀ was 0 and time t₁ was 62 hours. The absorbance decreased by about 25% (the amount of charge necessary was 53.6 coulombs).

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. Method for treating cork stoppers, wherein the cork is subjected to an electrochemical dehalogenation by electrolysis.

22. Method according to claim 21, wherein a solution is provided comprising an electrolyte in contact with the cork, electrodes in contact with said solution, and a generator suitable for applying a difference in potential between the electrodes.

23. Method according to claim 22, wherein the solution and the surface of the electrodes in contact with the solution are provided in biocompatible materials.

24. Method according to claim 22, having at least one of the following characteristics:
one electrode is a cathode, and a cathode surface material is lead,
one electrode is an anode, and an anode surface material is inert,
a solvent is an alcohol,
an electrolyte is a salt present in wine,
the cork is in the form of stoppers.

25. Method according to claim 22, wherein a tank containing the solution is provided, and wherein the electrodes and the cork are immersed in the solution.

26. Method according to claim 21, comprising at least one of the following characteristics:
the cork is kept completely immersed in the solution;
during the dehalogenation, a molecule contained in the haloanisole and halophenol groups is removed.

27. Method according to claim 21, wherein a halogen concentration is measured, and wherein the dehalogenation is controlled according to said concentration.

28. Method according to claim 21, wherein cork stoppers are formed.

29. Bottling method wherein a method for treating cork according to claim 21 is used, and wherein a bottle is sealed with one of said stoppers.

30. Facility comprising a cork supply unit, and an electrochemical station where the cork is subjected to an electrochemical dehalogenation by electrolysis, the facility further comprising a stopper shaping station,
the facility optionally further comprising a sealing station where a wine bottle is sealed with a stopper.

31. Method according to claim 24 wherein the anode surface material is graphite.

32. Method according to claim 24 wherein the solvent is ethanol.

33. Method according to claim 24 wherein the electrolyte is a sodium salt.

34. Method according to claim 33 wherein the sodium salt is selected from sodium acetate, sodium tartrate, and mixtures thereof.

35. Method according to claim 26 the molecule removed during dehalogenation is is 2,4,6-trichloroanisole.
